(19) United States
(12) Patent Application Publication
(10) Pub. No.: US 2026/0286563 A1
(43) Pub. Date: Sep. 24, 2026

(54) SYSTEMS AND METHODS FOR RINSING ELECTROPLATING ROTORS

(71) Applicant: Applied Materials, Inc., Santa Clara, CA (US)

(72) Inventors: Young Hee Im, Hwaseong-Si (KR); Jacob Leon Malkin, Kalispell, MT (US)

(73) Assignee: Applied Materials, Inc., Santa Clara, CA (US)

(21) Appl. No.: 19/088,315

(22) Filed: Mar. 24, 2025

(51) Int. Cl. C25D 21/08; B08B 3/02; B08B 13/00; C25D 17/06; C25D 21/10; C25D 21/12; F26B 5/00

(52) U.S. Cl. CPC C25D 21/08; B08B 3/022; B08B 13/00; C25D 17/06; C25D 21/10; C25D 21/12; F26B 5/00

(57) ABSTRACT

Exemplary methods of cleaning a rotor of an electroplating apparatus may include positioning a rotor of an electroplating apparatus into a rinse position. The methods may include rotating the rotor at a rinse speed. The methods may include spraying a rinsing fluid against a surface of the rotor using a rinse nozzle of the electroplating apparatus for a first period of time. The methods may include ceasing the spraying of the rinse fluid. The methods may include rotating the rotor at a dry speed for a second period of time.

### TECHNICAL FIELD

The present technology relates to cleaning operations in semiconductor processing. More specifically, the present technology relates to systems and methods that perform rinse operations in electroplating systems.

### BACKGROUND

Integrated circuits are made possible by processes which produce intricately patterned material layers on substrate surfaces. After formation, etching, and other processing on a substrate, metal or other conductive materials are often deposited or formed to provide the electrical connections between components. Because this metallization may be performed after many manufacturing operations, problems caused during the metallization may create expensive waste substrates or wafers.

During formation of metal materials on a wafer or substrate, a substrate may be submerged within a plating bath followed by metal formation on the substrate. Oftentimes, the plating solution may cause residue to be formed or deposited on a rotor of a substrate carrier head that holds the substrate within the plating bath. To prevent the residue from causing defects on substrates, the rotor may need to be regularly cleaned to eliminate the presence of residue. However, this may result in frequent and extended downtime for the electroplating systems, which may have negative impacts on plating throughput.

Thus, there is a need for improved systems and methods that can be used to produce high quality devices and structures while ensuring that the rotor remains free of contaminants from the plating bath. These and other needs are addressed by the present technology.

### SUMMARY

Exemplary methods of cleaning a rotor of an electroplating apparatus may include positioning a rotor of an electroplating apparatus into a rinse position. The methods may include rotating the rotor at a rinse speed. The methods may include spraying a rinsing fluid against a surface of the rotor using a rinse nozzle of the electroplating apparatus for a first period of time. The methods may include ceasing the spraying of the rinse fluid. The methods may include rotating the rotor at a dry speed for a second period of time.

In some embodiments, the dry speed may be greater than the rinse speed. The first period of time may be shorter than the second period of time. The methods may include determining whether the rotor may be free of contaminants based on data from one or more sensors. The methods may include adjusting one or both of the rinse speed and the first period of time based on determining whether the rotor is free of contaminants. The methods may include determining whether the rotor is free of the rinse fluid based on data from one or more sensors. The methods may include adjusting one or both of the dry speed and the second period of time based on determining whether the rotor is free of the rinse fluid. The rinse nozzle may be a first rinse nozzle positioned to deliver the rinse fluid to the surface of the rotor at an upward angle. The method may further spraying the rinsing fluid against the surface of the rotor at a substantially horizontal angle using a second rinse nozzle. Spraying the rinsing fluid against the surface of the rotor at the substantially horizontal angle using the second rinse nozzle may be performed simultaneously to spraying the rinsing fluid against the surface of the rotor using the first rinse nozzle.

Some embodiments of the present technology may encompass methods of cleaning a rotor of an electroplating apparatus. The methods may include positioning a rotor of an electroplating apparatus into a rinse position. The methods may include rotating the rotor at a rinse speed. The methods may include spraying a rinsing fluid against a surface of the rotor using a rinse nozzle of the electroplating apparatus for a first period of time. The methods may include ceasing the spraying of the rinse fluid. The methods may include rotating the rotor at a dry speed for a second period of time that is longer than the first period of time. The dry speed may be greater than the rinse speed.

In some embodiments, the rinse speed may be between 50 rpm and 600 rpm. The dry speed may be between 50 rpm and 500 rpm. The first period of time may be between 5 seconds and 60 seconds. The second period of time may be between 5 seconds and 300 seconds. One or both of the first period of time and the second period of time may include a predetermined amount of time. One or both of the rinse speed and the dry speed may include a predetermined rate of rotation.

Some embodiments of the present technology may encompass electroplating systems. The systems may include a plating vessel. The systems may include a substrate carrier head having a rotor. The substrate carrier head may be movable between a transfer position and a rinsing position in which at least a portion of the rotor is disposed within an interior of the plating vessel. The systems may include a rinse nozzle disposed within the interior of the plating vessel. The rinse nozzle may be oriented at an upward angle toward a bottom surface of the rotor when the substrate carrier head is in the rinsing position. The systems may include one or more processors that may be configured to position the rotor into the rinse position. The one or more processors may be configured to rotate the rotor at a rinse speed. The one or more processors may be configured to spray a rinsing fluid against the bottom surface of the rotor using the rinse nozzle of for a first period of time. The one or more processors may be configured to cease the spraying of the rinse fluid. The one or more processors may be configured to rotate the rotor at a dry speed for a second period of time.

In some embodiments, the rinse nozzle may be a first rinse nozzle. The electroplating system may include a second rinse nozzle disposed within the interior of the plating vessel. The second rinse nozzle may be oriented at a substantially horizontal angle relative to the bottom surface of the rotor. The systems may include one or more sensors that are configured to monitor one or more conditions of the bottom surface of the rotor. The one or more processors may be further configured to adjust at least one of the rinse speed, the first period of time, the dry speed, or the second period of time based on data from the one or more sensors. The one or more sensors may include at least one of an optical sensor that is oriented toward the bottom surface of the rotor, a laser sensor, or an ultrasonic sensor. The upward angle may be between 5 degrees and 35 degrees relative to horizontal. The rinse nozzle may be a first rinse nozzle of a plurality of rinse nozzles disposed at different angular positions about the interior of the plating vessel.

Such technology may provide numerous benefits over conventional technology. For example, the present technology may provide automated techniques for rinsing residue from plating solutions and/or other contaminants from the surface of the rotor, thereby eliminating or reducing the need for manual cleaning operations. This may reduce the system downtime and ultimately increase the throughput of electroplating systems. These and other embodiments, along with many of their advantages and features, are described in more detail in conjunction with the below description and attached figures.

### BRIEF DESCRIPTION OF THE DRAWINGS

A further understanding of the nature and advantages of the disclosed embodiments may be realized by reference to the remaining portions of the specification and the drawings.

FIG. 1 shows a schematic perspective view of a chamber on which cleaning technology may be coupled according to some embodiments of the present technology.

FIG. 2 shows a partial cross-sectional view of a chamber including aspects of rinsing components according to some embodiments of the present technology.

FIG. 2A shows a schematic partial top plan view of the chamber of FIG. 2 according to embodiments of the present technology.

FIG. 2B shows a schematic partial front elevation view of the chamber of FIG. 2 according to embodiments of the present technology.

FIG. 2C shows a partial cross-sectional view of the chamber of FIG. 2 in a rotor-rinsing configuration according to some embodiments of the present technology.

FIG. 3 is a flowchart illustrating operations of a method for rinsing a rotor of an electroplating system according to embodiments of the present technology.

Several of the figures are included as schematics. It is to be understood that the figures are for illustrative purposes and are not to be considered of scale unless specifically stated to be of scale. Additionally, as schematics, the figures are provided to aid comprehension and may not include all aspects or information compared to realistic representations and may include exaggerated material for illustrative purposes.

In the figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION

Various operations in semiconductor manufacturing and processing are performed to produce vast arrays of features across a substrate. As layers of semiconductor materials are formed, vias, trenches, and other pathways are produced within the structure. These features may then be filled with a conductive or metal material that allows electricity to conduct through the device from layer to layer.

Electroplating operations may be performed to provide conductive material into vias and other features on a substrate. Electroplating utilizes an electrolyte bath containing ions of the conductive material to electrochemically deposit the conductive material onto the substrate and into the features defined on the substrate. The substrate on which metal is being plated operates as the cathode. An electrical contact, such as a ring or pins, may allow the current to flow through the system. During electroplating, a substrate may be clamped to a head and submerged in the electroplating bath to form the metallization. In systems as described below, the substrate may also be chucked within a seal that may be coupled with the head during processing. This seal may help prevent the electroplating bath from contacting a rotor of the head. However, oftentimes there is some amount of contact between the electroplating bath and rotor. This may lead to residue from forming on the rotor. For example, in copper plating operations, crystals may form on a surface of the rotor, while in tin silver applications, a sticky sludge may form on the rotor. This residue may lead to lower seal lifetimes and may result in residue being deposited on a backside of wafers, which may lead to contamination of other chambers.

Conventional solutions involve manual cleaning operations in which the electroplating system is taken out of service and cleaned by a technician. Not only do such solutions require long and frequent downtimes, but the solutions also require significant technician time. Due to these factors, the cleaning operations are often performed at much longer intervals than recommended, leading to increased residue build up and, subsequently, shorter seal lifetimes and higher likelihood of chamber contamination.

The present technology overcomes these issues by incorporating an automated rotor cleaning processes may be performed in between plating operations, such as in a period of time between when a plated substrate is removed from the plating system and a new substrate is loaded into the plating system. In some embodiments, the cleaning processes may utilize rinse assemblies that are used to clean wafers in situ, enabling plating systems with such rinse assemblies to perform the rotor cleaning operations without modification to the plating system hardware. The cleaning systems may utilize rinse assemblies with nozzles that are positioned to limit fluid delivery into the bath and to prevent splashing, which may otherwise cause additional plating solution to contact the rotor. Additionally, by incorporating the rinse assemblies into plating systems (rather than moving the components to a stand-alone rinse chamber) may result in a reduced system footprint, operational cost, and number of robot movements required. In this manner, the present invention may promote increased carrier head seal lifetime and reduce the likelihood of chamber cross-contamination

Although the remaining disclosure will routinely identify specific rinsing processes utilizing the disclosed technology, it will be readily understood that the systems and methods are equally applicable to other seals in plating chambers and systems, as well as processes as may occur in the described systems and other semiconductor systems. Accordingly, the technology should not be considered to be so limited as for use with these specific plating processes or systems alone. The disclosure will discuss one possible system that may include electroplating components according to embodiments of the present technology before additional variations and adjustments to this system according to embodiments of the present technology are described.

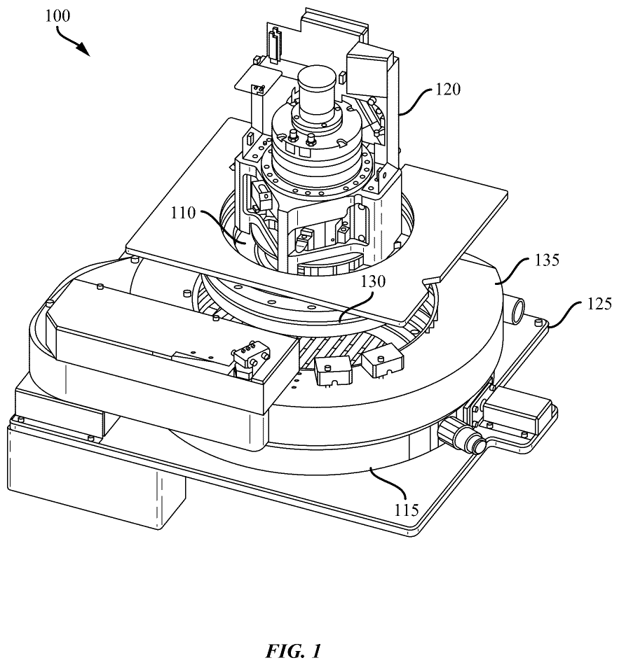

FIG. 1 shows a schematic isometric view of an electroplating system 100 for which methods and cleaning systems may be utilized and practiced according to embodiments of the present technology. Electroplating system 100 illustrates an exemplary electroplating system including a substrate carrier head 110 and a plating vessel 115. During electroplating operations, a wafer may be clamped to the substrate carrier head 110, inverted, and extended into the plating vessel 115 to perform an electroplating operation. Electroplating system 100 may include a head lifter 120, which may be configured to both raise and rotate the substrate carrier head 110 or otherwise move or position the substrate carrier head 110 within the electroplating system 100, including tilting operations. For example, the head lifter 120 may move the substrate carrier head 110 being a transfer position in which substrates may be transferred to and from the substrate carrier head 110 and a rinsing position in which at least the rotor and the substrate are brought into contact with a plating solution held within the plating vessel 115. The substrate carrier head 110 and plating vessel 115 may be attached to a deck plate 125 or other structure that may be part of a larger system incorporating multiple electroplating systems 100, and which may share electrolyte and other materials.

A rotor (not shown) may allow a substrate clamped to the substrate carrier head 110 to be rotated within the plating vessel 115, or outside the plating vessel 115 in different operations. The rotor may include a contact ring, which may provide the conductive contact with the substrate. A seal 130 discussed further below may be connected with the head. Seal 130 may include a chucked wafer to be processed. FIG. 1 illustrates an electroplating chamber that may include components to be cleaned directly on the platform. It is to be understood that other configurations are possible, including platforms on which the head is moved to an additional module and seal or other component cleaning is performed. Additionally, one or more components, such as seal 130 may be removed from a respective chamber and placed in a maintenance system or cleaning system for cleaning. Any number of other operations may be performed that provide or expose a component for cleaning. An exemplary in situ rinse system 135 is also illustrated with the system 100 and will be described in further detail below.

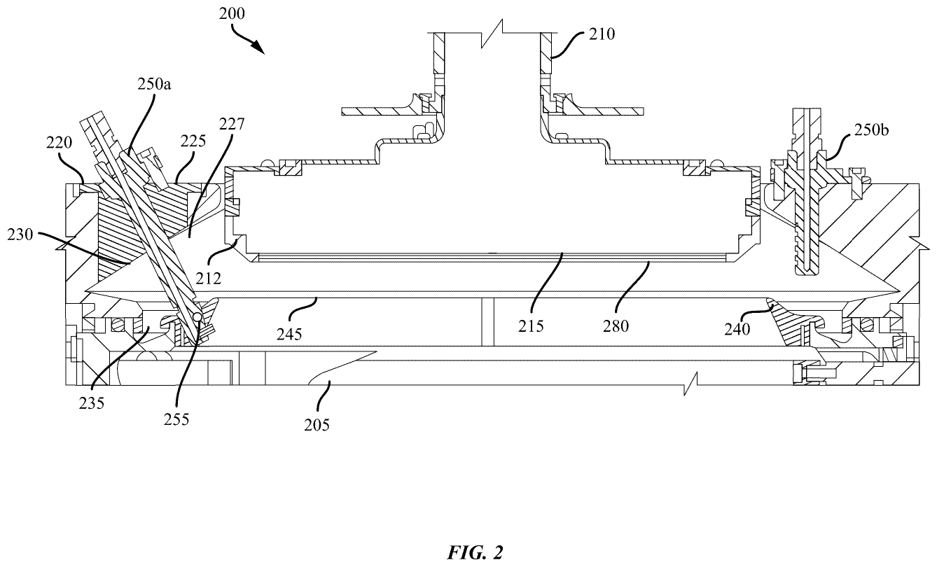

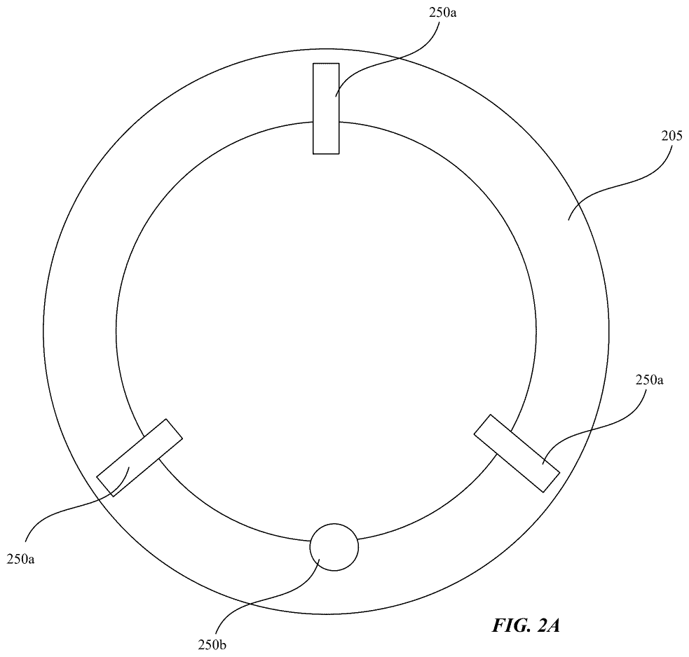

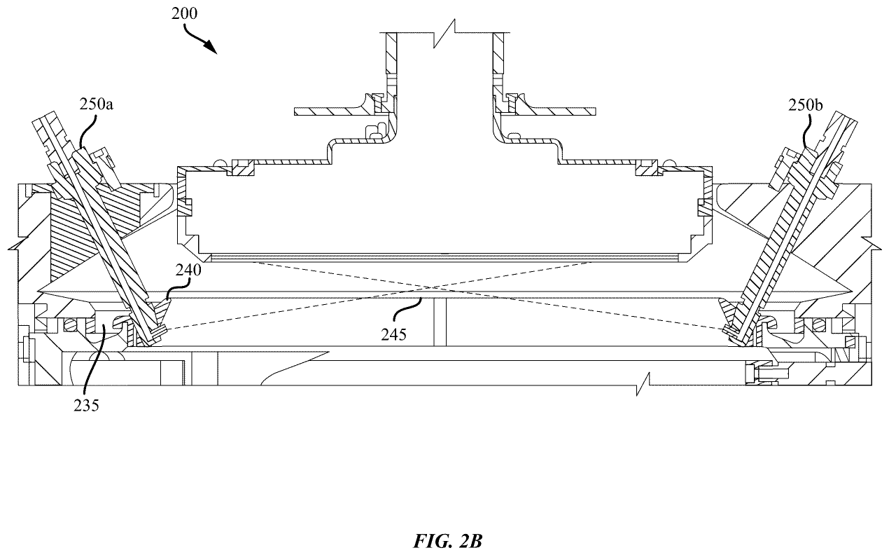

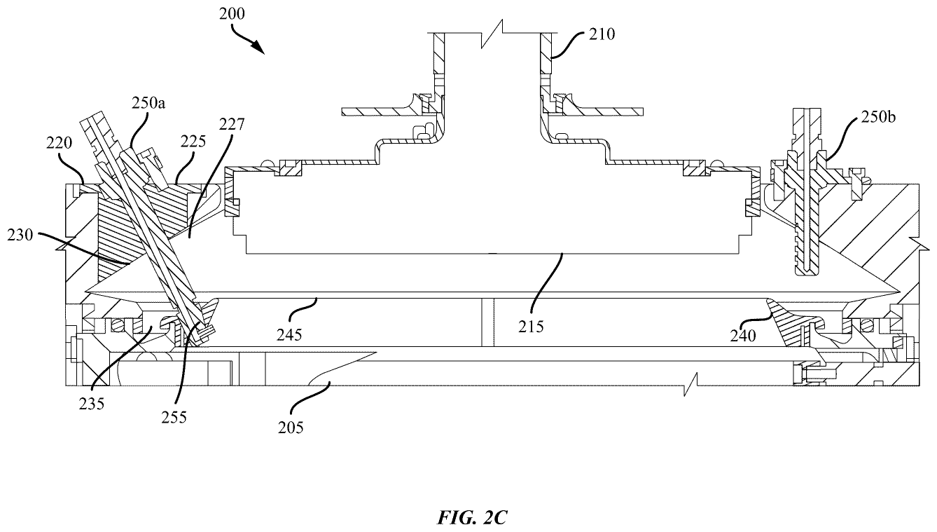

Turning to FIG. 2 is shown a partial cross-sectional view of a chamber including aspects of an electroplating apparatus 200 according to some embodiments of the present technology. The electroplating apparatus 200 may be incorporated with an electroplating system, including system 100 described above. As illustrated in FIG. 2, a plating bath vessel 205 of an electroplating system is shown along with a substrate carrier head 210 having a substrate 280 coupled thereto. For example, the substrate 280 may be clamped against or otherwise coupled with a rotor 215 of the substrate carrier head 210. The rotor 215 may be configured to rotate about a central axis to rotate the substrate 280 during plating and/or rinse operations. The substrate may be coupled with a seal 212 incorporated on the substrate carrier head 210 in some embodiments. A rinsing frame 220 may be coupled above the plating bath vessel 205 and may be configured to receive the substrate carrier head 210 into the plating bath vessel 205 during plating. Rinsing frame 220 may include a rim 225 extending circumferentially about an upper surface of the plating bath vessel 205. A rinsing channel 227 may be defined between the rim 225 and an upper surface of the plating bath vessel 205. For example, rim 225 may include interior sidewalls 230 characterized by a sloping profile. As described above, rinse fluid slung off the substrate 280 may contact the sidewalls 230 and may be received in a plenum 235 extending about the rim for collection of the rinse fluid from the electroplating apparatus 200. A weir 240 may extend about the plating bath vessel 205 and may be fluidly coupled with the plenum 235 or collection channel to further limit slung fluid from returning to the plating bath. The weir 240 may define a plane 245 across the electroplating apparatus 200, through which the substrate carrier head 210 may extend to enter the plating bath vessel 205, and through which the substrate carrier head 210 may return to perform a rinsing operation.

Electroplating apparatus 200 may additionally include one or more cleaning components in some embodiments, which may be used in a number of methods for in situ component cleaning. The components may include one or more rinse nozzles 250 used to deliver fluids to or towards the substrate 280 or the substrate carrier head 210, such as to a surface of the rotor 215. As shown in FIG. 2, the substrate carrier head 210 is in a rinsing position in which the rotor 215 and substrate 280 are disposed within an interior of the plating bath vessel 205. The rinsing position may be any location in which the substrate 280 is within the plating bath vessel 205 while being spaced apart from a top of the plating solution. In some embodiments, the rinsing position may be located at a height from the plating bath vessel 205 below the plane 245 defined by the weir 240 extending about the chamber, as previously described, and which may be fluidly coupled with the plenum 235 where fluids may be drained from the system.

As noted above, the electroplating apparatus 200 may include one or more rinse nozzles 250. For example, the electroplating apparatus 200 may include a number of first fluid nozzles 250a and/or a number of second fluid nozzles 250b. As illustrated, a first fluid nozzle 250a may extend through the weir 240 such that an outlet of the first fluid nozzle 250a is positioned below the substrate 280 and the rotor 215 when the substrate carrier head 210 is in the rinsing position. The outlet of the first fluid nozzle 250a may be oriented at an upward angle toward a bottom surface of the rotor 215 when the substrate carrier head 210 is in the rinsing position. For example, the outlet of the first fluid nozzle 250a may be oriented at an angle of between 5 degrees and 35 degrees relative to horizontal and more commonly between 10 degrees and 20 degrees relative to horizontal, although other angles may be possible depending on the distance between the outlet of the first rinse nozzle 250a and the substrate 280 and/or rotor 215. In some embodiments, the angle of the outlet of the first rinse nozzle 250a may enable the first rinse nozzle 250a to deliver rinse solution to a far side of the substrate 280 and/or rotor 215. For example, the first rinse nozzle 250a may deliver the rinse fluid beyond a central axis of the substrate 280 and/or rotor 215 such that the rinse fluid strikes the substrate 280 and/or rotor 215 at a position that is between the central axis and an opposite edge of the substrate 280 and/or rotor 215. Such positioning may, for example, enable the rinse fluid to strike positions that are more likely to come in contact with plating solution at angles that are more conducive to cleaning the rotor 215. In some embodiments, a vertical position and/or orientation of one or more of the nozzles 250 may be adjustable to control a contact angle and contact position of the rinse spray impinging on the substrate 280 and/or rotor 215.

While only a single first rinse nozzle 250a is illustrated, it will be appreciated that the electroplating apparatus 200 may include any number of first rinse nozzles 250a in various embodiments. For example, the electroplating apparatus 200 may include one or more first rinse nozzles, two or more first rinse nozzles, three or more first rinse nozzles, four or more first rinse nozzles, five or more first rinse nozzle, six or more first rinse nozzles, or more. Where multiple first rinse nozzles are included, each first rinse nozzle 250a may be positioned at a unique angular position, with the angular intervals between adjacent first rinse nozzles 250a being regular or irregular about the interior of the plating bath vessel 205. For example, as illustrated in FIG. 2A, three first rinse nozzles 250a, each positioned at a unique angular position about the plating bath vessel 205. In some embodiments, the outlet of each first rinse nozzle 250a may be at a same vertical position and/or spray angle relative to the plating bath vessel 205, while in other embodiments, one or more of the first rinse nozzles 250a may be at different vertical positions and/or spray angles than other first rinse nozzles 250a. For example, as illustrated in FIG. 2B, two first rinse nozzles 250a are illustrated, with one being positioned lower and with a higher spray angle than the other. The use of multiple first rinse nozzles 250a at different vertical positions and/or spray angles may enable the rinse fluid to contact a surface of the substrate 280 and/or rotor 215 at different locations and/or angles, which may facilitate improved cleaning of the surface. By delivering rinse fluid, such as deionized water or other rinse fluids, at angles as illustrated in some embodiments, the velocity of the delivery may be reduced, and rotation of the substrate carrier head 210 may be used to draw the rinse fluid radially outward along the substrate 280. The reduced velocity of delivery may limit upward splashing of fluid back down into the plating bath and may subsequently reduce dilution of the plating bath.

The electroplating apparatus 200 may include one or more second rinse nozzles 250b as best illustrated in FIG. 2. The second rinse nozzle 250b may include one or more fluid outlets that may deliver the rinse fluid towards edge regions of the substrate 280 and/or rotor 215. For example, the fluid outlets may be oriented to deliver the rinse fluid at a substantially horizontal (e.g., within 10 degrees of horizontal, within 5 degrees of horizontal, within 3 degrees of horizontal, within 1 degree of horizontal, or less) angle relative to the bottom surface of the substrate 280 and/or rotor 215. While shown with five outlets, it will be appreciated that the second rinse nozzle 250b may include any number of outlets in various embodiments. For example, the second rinse nozzle 250b may have one or more outlets, two or more outlets, three or more outlets, four or more outlets, five or more outlets, six or more outlets eight or more outlets, ten or more outlets, or more. The second rinse nozzle 250b may be positioned radially outward of the peripheral edge of the substrate carrier head 210 when the substrate carrier head 210 is in the rinsing position. Although shown on opposite sides of the plating bath vessel 205, it is to be understood that the first rinse nozzle 250a and second rinse nozzle 250b may exist at any location about the chamber, including adjacent one another. In some embodiment, the second rinse nozzle 250b may be at a different vertical position than the first rinse nozzle 250a. For example, as illustrated, the second rinse nozzle 250b may be higher than the first rinse nozzle 250a, such as by being positioned above the weir 240. This may, for example, enable the horizontal spray of rinse fluid from the second rinse nozzle 250b to reach the substrate 280 and/or rotor 215 simultaneously as the upwardly angled spray from the first rinse nozzles 250a. In other embodiments, the second rinse nozzle 250b may be positioned even higher or lower, and in some embodiments may extend through the weir 240.

The electroplating apparatus 200 may include one or more sensors 255 that may be configured to monitor one or more conditions of the bottom surface of the substrate 280 and/or rotor 215. For example, the sensors 255 may be designed to monitor whether the substrate 280 and/or rotor 215 are free from rinse fluid, plating solution, residue from the plating solution (e.g., crystals, sludge, etc.), and/or other contaminants. In some embodiments, the sensors 255 may be optical sensors, such as cameras and/or other imaging devices that are oriented at the bottom surface of the substrate 280 and/or rotor 215 and may optically monitor a surface of the substrate 280 and/or rotor 215 to determine whether any undesired materials remain on the surface. In some embodiments, other forms of sensors 255 may be utilized, such as ultrasonic sensors, laser sensors, and/or other sensors. In some embodiments, the sensors 255 may be positioned within the plating bath vessel 205 at a position that is in optical line of sight of the substrate 280 and/or rotor 215 when the substate carrier head 210 is in the rinsing position. For example, the sensors 255 may be positioned on the first or second rinse nozzles 250 and/or at other positions above and/or below the weir 240. Data from the sensors 255 may be used to control operations of the electroplating apparatus 200, such as a timing of one or more steps of a rinse operation and/or a rotor speed used during one or more steps of a rinse operation, as will be discussed in greater detail below.

As noted above, the rinse nozzles 250 may be used to rinse substrates after plating operations to remove residual plating solution that may remain on the substrate 280 after removal of the substrate 280 from the plating bath. For example, the substrate carrier head 210 may be raised to a rinsing position in which the substrate 280 is positioned above the weir 240. Rinse fluid may be delivered from one or more of the rinse nozzles 250 to push or expel residual bath fluid from the surface of the substrate 280, seal 212, and/or portions of the substrate carrier head 210. In some embodiments the rinse fluid may be delivered towards a bottom surface of the substrate while the rotor 215 is rotating, which may draw the rinse fluid radially outward across the substrate 280 before slinging the rinse fluid to the plenum 235, which may extend above and radially outward of the plating bath. The weir 240 may limit or prevent delivery back to the bath of fluids slung from the substrate when above the plane 245 defined by the weir 240 in some embodiments. The rinsing of the substrate 280 may be performed in one or more steps and/or at one or more rinsing positions in various embodiments.

PROCESSOR

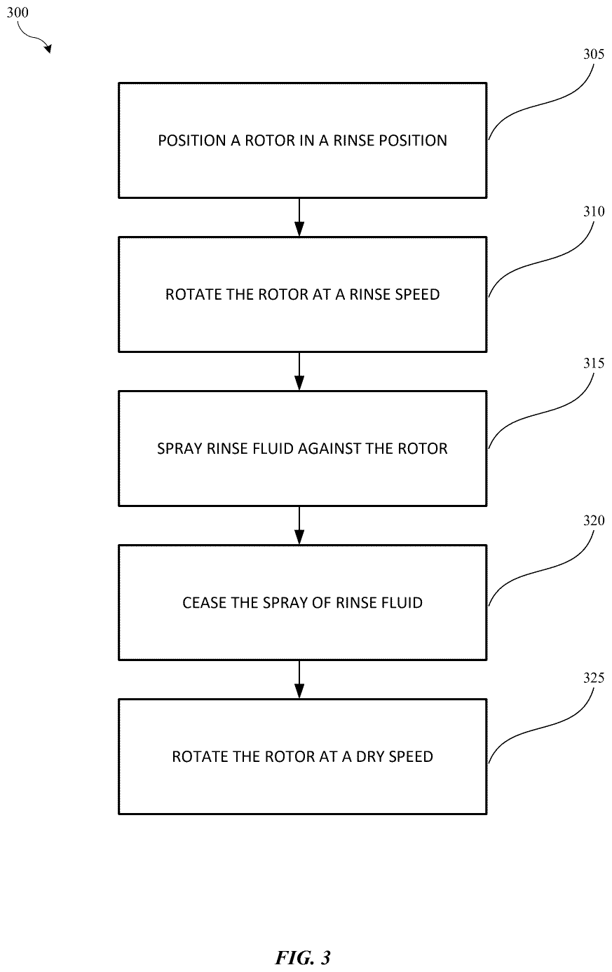

As noted above, the rinse nozzles 250 may also be used to perform methods of rinsing contaminants from the rotor 215. For example, FIG. 3 shows exemplary operations in a method 300 of rinsing a rotor at a semiconductor plating chamber according to some embodiments of the present technology, and which may use any of the components previously described. Method 300 may be performed in one or more electroplating systems, such as electroplating apparatus 200, which may be incorporated into processing system 100, for example, as well as any other semiconductor plating chambers adaptable to perform the operations described. The method may include a number of optional operations in some embodiments, which may or may not be specifically associated with some embodiments of methods according to the present technology. Method 300 describes operations shown schematically in FIGS. 2-2C, the illustrations of which will be described in conjunction with the operations of method 300. It is to be understood that FIGS. 2-2C illustrate only partial schematic views with limited details, and in some embodiments the systems may include more or fewer components, as well as alternative structural aspects or rearrangements that may still benefit from any of the aspects of the present technology. Additionally, while described in conjunction with FIGS. 2-2C, it will be appreciated that the operations of method 300 may be performed in a similar using rinsing nozzles in other electroplating apparatuses.

Method 300 may include operations prior to the actual rotor cleaning. For example, prior to the cleaning, a substrate carrier head may deliver a substrate into a plating bath vessel to perform an electroplating operation. The substrate carrier head may be moved or raised from the plating bath and one or more rinse operations may be performed to remove residual rinse solution from the surface of the substrate 280. After rinsing the substrate 280, the substrate carrier head 210 may be moved to a transfer position and the substrate 280 and seal 212 may be removed, exposing a bottom surface of the rotor 215. At operation 305, the method 300 may include positioning the rotor 215 into a rinse position as illustrated in FIG. 2C. In the rinse position, the rotor 215 is positioned within an interior of the plating bath vessel 205 and is vertically spaced apart from an upper surface of the plating bath. For example, the bottom surface of the rotor 215 may be positioned above the weir 240 and plane 245 in some embodiments. In some embodiments, when the substrate carrier head 210 is in the rinsing position, the outlets of one or more of the first rinse nozzles 250a may be at a vertical distance of between 25 mm and 200 mm below the bottom surface of the rotor 215. Based on the orientation of the outlets of the first rinse nozzles 250a, a straight line distance between each outlet and the respective contact point of the rinse fluid on the rotor 215 may be between 100 mm and 400 mm, and more commonly between 200 mm and 300 mm. Such a rinsing position may help ensure that all or a substantial portion of rinse fluid slung off from a surface of the rotor 215 may be collected within the plenum 235 where fluids may be drained from the system, rather than falling into and potentially diluting the plating bath.

Once the rotor 215 is in the rinsing position, the rotor 215 may be rotated at a rinse speed at operation 310. For example, a rotation speed of the rotor 215 may be gradually ramped up to the rinse speed. In some embodiments, the rinse speed may be between 50 rpm and 500 rpm, although other rotation rates may be possible in some embodiments. While the rotor 215 is at the rinse speed, the method 300 may include spraying a rinse fluid against a surface of the rotor 215 using one or more rinse nozzles 250 of the electroplating apparatus 200 for a first period of time at operation 315. The rinse fluid may include, for example, water (such as deionized water), any number of cleaners, acids, organic solvents, and/or rinsing agents used in any variety of plating systems to clean substrates and/or system components. The rinse nozzles 250 may include any combination of one or more of the first rinse nozzles 250a and/or one or more of the second rinse nozzles 250b. Where multiple rinse nozzles 250 are used, some or all of the rinse nozzles 250 may spray rinse fluid simultaneously, while in other embodiments, one or more of the rinse nozzles 250 may be activated sequentially. In some embodiments, the vertical position of the substrate carrier head 210 may be adjusted in situ to change a contact position and/or angle of the rinse fluid from one or more of the rinse nozzles 250 and/or to switch rinse nozzles 250 (e.g., switch from spraying with the first rinse nozzles 250a to the second rinse nozzles 250b). Any number of combinations of spray orders may be used in various embodiments. The rinse solution may be supplied as a continuous stream and/or in a pulsed manner in various embodiments. For example, the pulsed manner may include periods of high flow separated by periods of low or no flow. In some embodiments, a flow rate, pressure, and/or velocity of the rinse fluid may remain constant throughout the rinsing operation, while in other embodiments one or more of these parameters may be varied during a given rinse operation or series of rinse operations.

In some embodiments, the spray of rinse fluid may begin before, simultaneously to, and/or after the rotation of the rotor 215 has begun. However, it may be preferable to begin the spray of rinse fluid after the rotor 215 has reached the rinse speed and/or other threshold speed that may help facilitate slinging of rinse fluid from the rotor 215 to the plenum 235. For example, if the rotor 215 is rotating too slowly when the spray begins, the rotational force of the rotor 215 may be insufficient to deliver rinse fluid to the plenum 235 after the spray has contacted the rotor 215. In such instances, the rinse fluid may fall into the plating bath, which may cause dilution of the plating bath and/or splashing that may deposit plating solution onto the rotor 215. The first period of time may be between 5 seconds and 60 seconds in some embodiments, although longer or shorter rinse times are possible in various embodiments.

Upon completion of the rinse operation (e.g., after the first period of time has elapsed), the rotor 215 may be dried (e.g., the rinse fluid may be removed from the rotor 215). For example, the method 300 may include ceasing the spray of the rinse fluid at operation 320. Upon ceasing delivery of the rinse fluid, the method 300 may include rotating the rotor 215 at a dry speed for a second period of time at operation 325. In some embodiments, the dry speed may be greater than the rinse speed, while in other embodiments the dry speed may be less than or equal to the rinse speed. For example, the dry speed may be between 50 rpm and 500 rpm in some embodiments, although other rates of speed may be possible. The second period of time may be greater than the first period of time in some embodiments, while in other embodiments the second period of time may be less than or equal to the first period of time. For example, the second period of time may be between 5 seconds and 500 seconds, more commonly between 60 second and 300 seconds in some embodiments.

In some embodiments, the operational parameters (e.g., rotor speed, operation times, nozzle angle/position, etc.) of the method 300 may be predetermined. For example, each time the rotor 215 is rinsed, the rotor 215 may be rotated at a same rinse speed for a first period of time of a consistent duration. Similarly, the rotor 215 may be rotated at a same dry speed for a second period of time of a consistent duration. In other embodiments, one or more operational parameters of the method 300 may be adjusted based on data from one or more of the sensors 255. For example, during the rinse cycle, data from the sensors 255 may be used to determine whether the rotor is free of contaminants such as plating solution, residue caused by the plating solution, and/or other contaminants. Based on this data, the rinse speed and/or the first period of time may be adjusted. For example, if contaminants are detected and/or are not being rinsed away at a desired rate, the electroplating apparatus 200 may increase the rinse speed of the rotor 215, increase a duration of the first period of time, adjust a vertical position and/or spray angle of the rinse nozzles 250 (e.g., adjust a position and/or orientation of the nozzles 250, change which nozzles 250 are activated, change a vertical rinsing position of the substrate carrier head 210, etc.), and/or otherwise adjust one or more parameters of the rinse operation. Similarly, if the data from the sensors 255 indicate that there are little to no contaminants present on the rotor 215, the rinse speed and/or the first period of time may be reduced.

The sensor data may also be used to control one or more parameters related to drying the rotor 215. For example, during the dry cycle, data from the sensors 255 may be used to determine whether the rotor is free of residual rinse fluid. Based on this data, the dry speed and/or the second period of time may be adjusted. For example, if residual rinse fluid is detected and/or is not being rinsed away at a desire rate, the electroplating apparatus 200 may increase the dry speed of the rotor 215, increase a duration of the second period of time, and/or otherwise adjust one or more parameters of the dry operation. Similarly, if the data from the sensors 255 indicate that there is little to no residual rinse fluid present on the rotor 215, the dry speed and/or the second period of time may be reduced.

While described as a single-stage rinsing process (e.g., a single rinsing operation and a single drying operation), it will be appreciated that multiple stage rinsing processes may be used in various embodiments. For example, a first rinsing operation may be performed using the first rinse nozzles 250a followed by a second rinsing operation performed using the second rinse nozzles 250b. In some embodiments, the first and second rinsing operations may be performed back-to-back, while in other embodiments they may be separated by a drying operation. For example, each rinsing operation may be immediately followed by a dedicated drying operation. In other embodiments, subsets of the first rinse nozzles 250a (e.g., single nozzles and/or other small subsets of nozzles) may each perform distinct rinse operations, with or without corresponding drying operations. In some embodiments, the vertical position of the substrate carrier head 210 may be changed between one or more rinse stages, which may adjust the contact location and/or location of the rinse fluid on the rotor 215 to more effectively clean the entire surface of the rotor 215.

As noted above, the rotor 215 may be rotated at various rinse and dry speeds during performance of the method 300. Higher speeds may promote better sling off delivery of the rinse fluid to the plenum 235, while slower speeds may promote better surface coverage of the rinse fluid across the surface of the rotor 215. For example, in various embodiments, the rotor 215 may be rotated at a variety of rotational speeds, such as from greater than or about 50 rpm up to or about 1,000 rpm or more, depending on the system components. The size of the rotor 215 may also impact the speed used, where faster rotational speeds may be used for smaller rotors 215 due to the reduced angular momentum, which may otherwise reduce the effectiveness of the sling if not compensated, such as with faster rotation. In some embodiments, higher rotational speeds may affect the head, which may cause an amount of perturbation, such as vertical or radial wobble of the substrate carrier head 210. Accordingly, in some embodiments, the substrate carrier head 210 may be rotated below or about 1,500 rpm, below or about 1,200 rpm, below or about 1,000 rpm, below or about 800 rpm, below or about 700 rpm, below or about 600 rpm, or less, which again may be at least partially based on system size, components, and operating conditions.

The substrate carrier head 210 may also be translated vertically during any of these periods of time in some embodiments, and may be adjusted during delivery of the rinse fluid. For example, rinse fluid may be delivered towards the bottom surface of the rotor 215 while the substrate carrier head 210 is rotating, to draw fluid radially outward across the rotor 215. During this delivery, the substrate carrier head 210 may be raised to adjust the contact angle and/or location of the rinse fluid on the rotor 215. For example, the substrate carrier head 210 may be raised or moved during this delivery so that the rinse fluid may impinge along a radially outward path along the rotor 215, and may impinge on a position at an external radial edge of the rotor 215 proximate a peripheral seal of the substrate carrier head 210, which may be characterized by a crevice, which may be rinsed with rinse fluid in some embodiments. In some embodiments, vertical translation of the substrate carrier head 210 may be perform while the rinse fluid is being sprayed, while in other embodiments the spray may be halted during movement of the substrate carrier head 210.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having disclosed several embodiments, it will be recognized by those of skill in the art that various modifications, alternative constructions, and equivalents may be used without departing from the spirit of the embodiments. Additionally, a number of well-known processes and elements have not been described in order to avoid unnecessarily obscuring the present technology. Accordingly, the above description should not be taken as limiting the scope of the technology.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein and in the appended claims, the singular forms “a”, “an”, and “the” include plural references unless the context clearly dictates otherwise. Thus, for example, reference to “a heater” includes a plurality of such heaters, and reference to “the mesh” includes reference to one or more meshes and equivalents thereof known to those skilled in the art, and so forth.

Also, the words “comprise(s)”, “comprising”, “contain(s)”, “containing”, “include(s)”, and “including”, when used in this specification and in the following claims, are intended to specify the presence of stated features, integers, components, or operations, but they do not preclude the presence or addition of one or more other features, integers, components, operations, acts, or groups.

What is claimed is:

1. A method of cleaning a rotor of an electroplating apparatus, comprising:
positioning a rotor of an electroplating apparatus into a rinse position;
rotating the rotor at a rinse speed;
spraying a rinsing fluid against a surface of the rotor using a rinse nozzle of the electroplating apparatus for a first period of time;
ceasing the spraying of the rinse fluid; and
rotating the rotor at a dry speed for a second period of time.

2. The method of cleaning a rotor of an electroplating apparatus of claim 1, wherein:
the dry speed is greater than the rinse speed.

3. The method of cleaning a rotor of an electroplating apparatus of claim 1, wherein:
the first period of time is shorter than the second period of time.

4. The method of cleaning a rotor of an electroplating apparatus of claim 1, further comprising:
determining whether the rotor is free of contaminants based on data from one or more sensors; and
adjusting one or both of the rinse speed and the first period of time based on determining whether the rotor is free of contaminants.

5. The method of cleaning a rotor of an electroplating apparatus of claim 1, further comprising:
determining whether the rotor is free of the rinse fluid based on data from one or more sensors; and
adjusting one or both of the dry speed and the second period of time based on determining whether the rotor is free of the rinse fluid.

6. The method of cleaning a rotor of an electroplating apparatus of claim 1, wherein:
the rinse nozzle comprises a first rinse nozzle positioned to deliver the rinse fluid to the surface of the rotor at an upward angle; and
the method further comprises spraying the rinsing fluid against the surface of the rotor at a substantially horizontal angle using a second rinse nozzle.

7. The method of cleaning a rotor of an electroplating apparatus of claim 6, wherein:
spraying the rinsing fluid against the surface of the rotor at the substantially horizontal angle using the second rinse nozzle is performed simultaneously to spraying the rinsing fluid against the surface of the rotor using the first rinse nozzle.

8. A method of cleaning a rotor of an electroplating apparatus, comprising:
positioning a rotor of an electroplating apparatus into a rinse position;
rotating the rotor at a rinse speed;
spraying a rinsing fluid against a surface of the rotor using a rinse nozzle of the electroplating apparatus for a first period of time;
ceasing the spraying of the rinse fluid; and
rotating the rotor at a dry speed for a second period of time that is longer than the first period of time, wherein the dry speed is greater than the rinse speed.

9. The method of cleaning a rotor of an electroplating apparatus of claim 8, wherein:
the rinse speed is between 50 rpm and 500 rpm.

10. The method of cleaning a rotor of an electroplating apparatus of claim 8, wherein:
the dry speed is between 50 rpm and 500 rpm.

11. The method of cleaning a rotor of an electroplating apparatus of claim 8, wherein:
the first period of time is between 5 seconds and 60 seconds.

12. The method of cleaning a rotor of an electroplating apparatus of claim 8, wherein:
the second period of time is between 5 seconds and 300 seconds.

13. The method of cleaning a rotor of an electroplating apparatus of claim 8, wherein:
one or both of the first period of time and the second period of time comprises a predetermined amount of time.

14. The method of cleaning a rotor of an electroplating apparatus of claim 8, wherein:
one or both of the rinse speed and the dry speed comprises a predetermined rate of rotation.

15. An electroplating system, comprising:
a plating vessel;
a substrate carrier head comprising a rotor, the substrate carrier head being movable between a transfer position and a rinsing position in which at least a portion of the rotor is disposed within an interior of the plating vessel;
a rinse nozzle disposed within the interior of the plating vessel, the rinse nozzle being oriented at an upward angle toward a bottom surface of the rotor when the substrate carrier head is in the rinsing position; and
one or more processors that are configured to:
position the rotor into the rinse position;
rotate the rotor at a rinse speed;
spray a rinsing fluid against the bottom surface of the rotor using the rinse nozzle of for a first period of time;
cease the spraying of the rinse fluid; and
rotate the rotor at a dry speed for a second period of time.

16. The electroplating system of claim 15, wherein:
the rinse nozzle comprises a first rinse nozzle; and
the electroplating system further comprises a second rinse nozzle disposed within the interior of the plating vessel, the second rinse nozzle being oriented at a substantially horizontal angle relative to the bottom surface of the rotor.

17. The electroplating system of claim 15, further comprising:
one or more sensors that are configured to monitor one or more conditions of the bottom surface of the rotor, wherein the one or more processors are further configured to adjust at least one of the rinse speed, the first period of time, the dry speed, or the second period of time based on data from the one or more sensors.

18. The electroplating system of claim 17, wherein:
the one or more sensors comprise at least one of an optical sensor that is oriented toward the bottom surface of the rotor, a laser sensor, or an ultrasonic sensor.

19. The electroplating system of claim 15, wherein:
the upward angle is between 5 degrees and 35 degrees relative to horizontal.

20. The electroplating system of claim 15, wherein:
the rinse nozzle comprises a first rinse nozzle of a plurality of rinse nozzles disposed at different angular positions about the interior of the plating vessel.
